(19) United States
(12) Patent Application Publication
(10) Pub. No.: US 2009/0268450 A1
(43) Pub. Date: Oct. 29, 2009

(54) LIGHTING DEVICE AND METHOD OF PRODUCING THE SAME

(76) Inventors: Katsutoshi Kojoh, Nara (JP); Hitoshi Sannomiya, Osaka (JP); Yoshimichi Kato, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/092,327

(22) PCT Filed: Nov. 24, 2006
(86) PCT No.: PCT/JP2006/323401

§ 371 Date: May 1, 2008

(30) Foreign Application Priority Data
Nov. 28, 2005 (JP) 2005-342395

(51) Int. Cl. F21V 1/00; H01J 9/24

(52) U.S. Cl. 362/235; 445/23

(57) ABSTRACT

A lighting device includes an optically transmissive glass substrate (1), a wiring pattern (2) formed on the glass substrate, and a plurality of light-emitting diode elements (4) mounted to correspond to the wiring pattern.

### TECHNICAL FIELD

The present invention relates to improvements in a lighting device and a method of producing the same, and more particularly to improvements in a lighting device including a plurality of LEDs (light-emitting diodes) and a method of producing the same.

### BACKGROUND ART

In recent years, the market for lighting devices using LEDs has been expanded rapidly from a viewpoint of low power consumption and long lifetime.

However, most of the LED lighting devices that are currently commercialized merely serve as substitutes for conventional lighting apparatuses (e.g., see Patent Document 1 of Japanese Patent Laying-Open No. 2003-124528). Patent Document 1: Japanese Patent Laying-Open No. 2003-124528

### DISCLOSURE OF THE INVENTION

### Problems to be Solved by the Invention

Here, the present inventors have conceived that it would be convenient to have an LED lighting device capable of introducing light into the interior of a building from the outside. For example, it would be beneficial to make it possible to introduce sunlight through LED-mounted substrates into the building.

However, when it is attempted to develop an LED lighting device that includes a daylighting property, it is expected that the attempt will involve various technical problems. For example, in the case that a daylighting property is imparted to an LED lighting device, the device must be stable even for long-term use and provided at low cost in a simple and easy manner so as to achieve wide popularity.

Therefore, an object of the present invention is to develop and provide an LED lighting device that includes a daylighting property, solving such various technical problems.

### Means for Solving the Problems

A lighting device according to the present invention includes an optically transmissive glass substrate, a wiring pattern formed on the glass substrate, and a plurality of light-emitting diode elements mounted to correspond to the wiring pattern.

Preferably, such a lighting device further includes a frame body made of resin or glass and enclosing the glass substrate. Furthermore, the glass substrate is preferably sealed in the frame body with resin.

Preferably, the wiring pattern is formed of a material containing silver, silicon, boron, and bismuth. The glass substrate may be made of colorless or colored transparent glass, or colorless or colored ground glass.

The wiring pattern can be formed linearly along two side edges facing each other of the glass substrate and include a pattern for connection with an interconnector. Furthermore, the wiring pattern is preferably formed to be rotationally symmetrical through 180 degrees. The lighting device may further include a glass coat covering at least a part of the wiring pattern. The glass coat may be a two-layered glass coat. The glass coat may also be formed of SiO₂.

Preferably, openings are provided at appropriate sites of the glass coat. An appropriate amount of cream solder may be applied in the opening. More specifically, it is preferable that the wiring pattern includes a land pattern on which the light-emitting diode element is mounted, and that in the glass coat covering the land pattern, the opening is formed with a prescribed inward distance from the outer peripheral edge of the land pattern. Furthermore, an electrode terminal of the LED can easily be soldered in the opening on the land pattern.

In a method of producing the above-described lighting device, the interconnector is preferably connected onto the wiring pattern by using reflow soldering. Furthermore, in the production method, the wiring pattern is preferably formed by baking a paste containing silver at a temperature of at least 490° C.

### EFFECTS OF THE INVENTION

According to the present invention described above, it is possible to provide at low cost in a simple and easy manner an LED lighting device that includes a daylighting property and is stable even for long-term use.

### BRIEF DESCRIPTION OF THE DRAWINGS

FIG. 1 is a flowchart that shows a process of producing an LED lighting device according to a first example of the present invention.

FIG. 2 is a schematic plan view that shows a wiring pattern on a glass substrate in the production process of FIG. 1.

FIG. 3(A) is a schematic plan view that shows an LED-mounted portion on the glass substrate and its neighborhood, and FIG. 3(B) is a schematic cross-sectional view corresponding thereto, in the production process of FIG. 1.

FIG. 4 is a schematic plan view that includes a circuit diagram corresponding to an arrangement of circuit elements mounted on the glass substrate in the production process of FIG. 1.

FIG. 5 is a schematic plan view that shows an arrangement of a plurality of glass substrates each mounted with LEDs in the production process of FIG. 1.

FIG. 6 is a schematic cross-sectional view corresponding to FIG. 5.

FIG. 7 is a schematic plan view that shows an arrangement of the plurality of glass substrates and an arrangement of the circuit elements mounted on wirings on these glass substrates in the production process of FIG. 1.

FIG. 8 is a schematic plan view that includes a circuit diagram corresponding to FIG. 7.

FIG. 9 is a schematic cross-sectional view of an LED lighting device in a production process according to a modification of the first example of the present invention.

FIG. 10 is a schematic plan view that shows a region where an LED is to be mounted on a glass substrate, i.e., a solder connection site (land pattern), and its neighborhood in a second example of the present invention.

FIG. 11 is a schematic plan view that shows shrinkage directions of cream solder applied on the land pattern in FIG. 10.

FIG. 12 is a schematic plan view that shows an opening provided in a glass coat covering the wiring pattern on the glass substrate in the second example of the present invention.

### DESCRIPTION OF THE REFERENCE SIGNS

1: glass substrate, 2: Ag paste wiring, 3: glass coating material, 4: LED, 5; solder, 6: limiting resistor, 7; Zener diode, 8: attachment glass board for fixing glass substrates, 9: cover made of polycarbonate for protecting LED substrates, 9a: cover made of glass for protecting LED substrates, 10: wiring for supplying LEDs with electric power and interconnector wiring (anode side), 11: wiring for supplying LEDs with electric power and interconnector wiring (cathode side), 12: EVA resin, 13: land pattern, 14: opening.

### BEST MODES FOR CARRYING OUT THE INVENTION

The present inventors studied in advance various technical problems that would arise in developing an LED lighting device that includes a daylighting property.

To begin with, in a conventional LED lighting device, a plurality of LEDs are mounted on an opaque substrate, and hence daylighting by sunlight and the like is not assumed basically. For example, there has widely been used a method of mounting a plurality of LEDs on a glass epoxy printed-board or a wiring pattern having a heat sink structure made of Al or Cu as a measure to dissipate heat (e.g., see Patent Document 1). Here, when it is attempted to achieve sufficient brightness and a sufficient daylighting property for serving as a lighting device, it is considered that there may occur a case where the LED lighting device will inevitably be deteriorated in its appearance or design.

It is conceivable that a sputtering method, an evaporation method, or the like may be used as a method of forming a wiring pattern on a transmissive glass substrate. However, it is considered that such a method may cause a problem of increase in formation cost and also cause a problem of decrease in accuracy of the wiring pattern as the formation cycle of the wiring pattern is repeated many times. Decrease in accuracy of the wiring pattern would cause non-uniform resistance of wiring and also be unfavorable in terms of appearance or design of the LED lighting device.

Heat in LEDs is generally dissipated via a wiring pattern, and hence it is conceivable that the thickness of the wiring pattern may be increased in order to prolong lifetime of the LEDs. However, if the thickness of the wiring pattern is increased in the above-described method of forming the wiring pattern, there will arise a problem of decrease in operation efficiency of the film-forming apparatus and thus increase in formation cost.

In the case of using a substrate of a material, e.g., a transmissive resin other than a glass, it is necessary to make connection using an Ag paste or the like in an LED mounting (connecting) method, and hence the adhesive strength of the connection is lower as compared with connection formed using solder. Furthermore, long-term use of the lighting device may cause degradation of the Ag paste due to ultraviolet rays and lead to lighting failure of the LEDs.

As to the wiring pattern to be formed on a transmissive glass substrate, it would be desired that the wiring pattern is capable of preventing erroneous mounting in the step of mounting LEDs and also capable of making it possible to connect a plurality of such glass substrates.

If the Ag paste is not protected, it may be sulfurized under the influence of moisture in the atmosphere and may cause electrical malfunction and deterioration in its appearance or design.

In an LED lighting device that uses a transmissive glass substrate, merely the use of a transparent and colorless glass substrate may decrease versatility in the case that a light-blocking property is somewhat sought in summer, or in the case that appearance or design of the building is considered.

In the case that the wiring pattern is formed of an Ag paste on a transmissive glass substrate, if the Ag paste is baked at a so-called lower temperature (e.g., approximately 150° C.), there will arise a problem of insufficient strength of adhesion to the transmissive glass substrate.

In a method of connecting a plurality of transmissive glass substrates with one another, they are connected with use of a wiring material referred to as an interconnector. However, if the interconnector is connected by manual soldering onto the wiring pattern that has been formed through printing and baking of an Ag paste, the solder reacts with the wiring pattern to thereby cause dissolution of Ag in the wiring material, and this may be a cause of poor connection.

As to the wiring pattern to be formed on a transmissive glass substrate, it would be desired that the wiring pattern is suitable for enabling reliable wire connection with no error, when the plurality of glass substrates are connected.

The present invention makes it possible to provide at low cost in a simple and easy manner an LED lighting device that includes a daylighting property and is stable even for long-term use, overcoming the various problems expected as described above.

Specifically, in the present invention, a wiring pattern is formed on a transmissive glass substrate and LEDs are mounted thereon, without use of an opaque substrate (a glass epoxy printed-board or a metal substrate having a heat sink structure made of Al or Cu) that has conventionally been used for mounting LEDs. By doing so, it is possible to ensure optical transmission from a side opposite to a light-emitting surface side of the substrate where a plurality of LEDs are arranged, namely, from a substrate side, so that the scope of utilization of the LED lighting device is expanded in the case that it is provided on, e.g., a building where daylighting is desired.

As to the LED lighting device alone that uses the transmissive glass substrate, the field of application thereof is limited to daylighting and lighting, and hence further improvement in versatility can be considered. In such a case, it is also possible to further improve versatility of the LED lighting device, by combining an optically transmissible solar battery system (thin-film see-through solar battery system), e.g., with a housing portion that holds the transmissive glass substrate.

As a method of forming a wiring pattern on the transmissive glass substrate, it is possible to adopt a method of printing and baking an Ag paste, which method can be performed at high accuracy and low cost and causes low wiring resistance. In the method of printing and baking the Ag paste, it is desirable to utilize a baking temperature of at least approximately 450° C. It is thereby possible to improve accuracy and resistance of the wiring pattern, both of which have been the problems to be solved in the conventional techniques. In addition, it is also possible to produce an LED lighting device at low cost.

By using the glass substrate as the substrate for mounting LEDs, it is possible to mount LEDs through solder connection. If LEDs are to be mounted on a resin substrate, a heat-resistant temperature of the resin is approximately 130° C. and hence solder connection is difficult, so that an electrically-conductive adhesive such as an Ag paste is usually used. The Ag paste has an adhesive strength lower than that of solder, and the resin substrate easily deforms if it has a small thickness. Accordingly, it is preferable that LEDs are fixed with solder, from a viewpoint of preventing occurrence of poor connection.

As to the wiring pattern formed on the transmissive glass substrate, it is preferable that the wiring pattern formed on the transmissive glass substrate is rotationally symmetrical through 180 degrees in order to prevent erroneous mounting in the step of mounting LEDs and make it possible to connect a plurality of such glass substrates.

If the Ag paste is not protected, it may be sulfurized under the influence of moisture in the atmosphere. Then, this may cause electrical malfunction in the LED lighting device and also degradation in appearance or design of the LED lighting device. In the present invention, therefore, it is made possible to avoid these problems by applying a glass coating to a surface of the Ag paste wiring. However, only a single-layered glass coating may include pinholes in its formation process and may not be sufficient to serve as a protective film. It is therefore preferable to apply an at least two-layered glass coating.

The LED fighting device that uses the transmissive glass substrate requires a structure for attaching the glass substrate to the building. It is possible to solve this problem by covering the transmissive glass substrate with a transmissive resin lid that serves as a housing for protecting the same, suppressing increase in weight and improving easiness in handling (installation).

In the LED lighting device that uses the transmissive glass substrate, if the glass substrate is limited to transparent and colorless one, versatility of the LED lighting device is inevitably decreased in the case that a light-blocking property is somewhat sought, or in the case that appearance or design of the building is considered. In such a situation, by using colored transparent glass, or colorless or colored ground glass as the substrate for mounting LEDs, it is possible to further improve versatility of the LED lighting device. In particular, the transmissive substrate made of ground glass can provide an advantage that the daylighting property can be ensured and, in addition, see-through from the outside can be prevented.

In this case, the LED-mounted glass substrate itself controls an optical transmission property (daylighting property), and hence the lighting property (illuminance) of the LEDs is not deteriorated.

When a plurality of transmissive glass substrates are to be connected, they are connected with use of a coupling material referred to as an interconnector. In this case, it is possible to avoid the problem of dissolution of the Ag paste wiring due to the solder, by connecting in advance the interconnector with reflow soldering onto the wiring pattern formed through printing and baking of an Ag paste, and interconnecting the interconnectors so as to interconnect the plurality of glass substrates.

### First Example

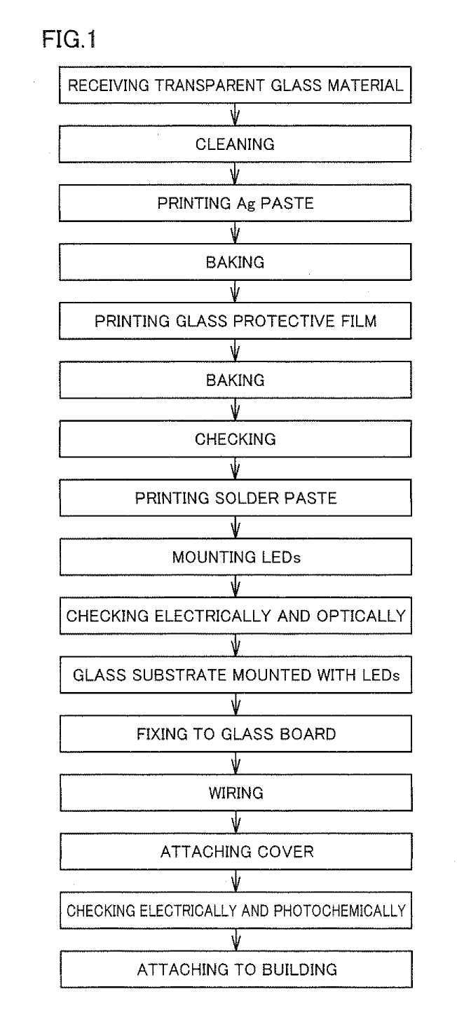

A flowchart in FIG. 1 shows steps of producing an LED lighting device that uses a transparent glass substrate in a first example of the present invention. As shown in this flowchart a transparent glass material is initially received as a substrate.

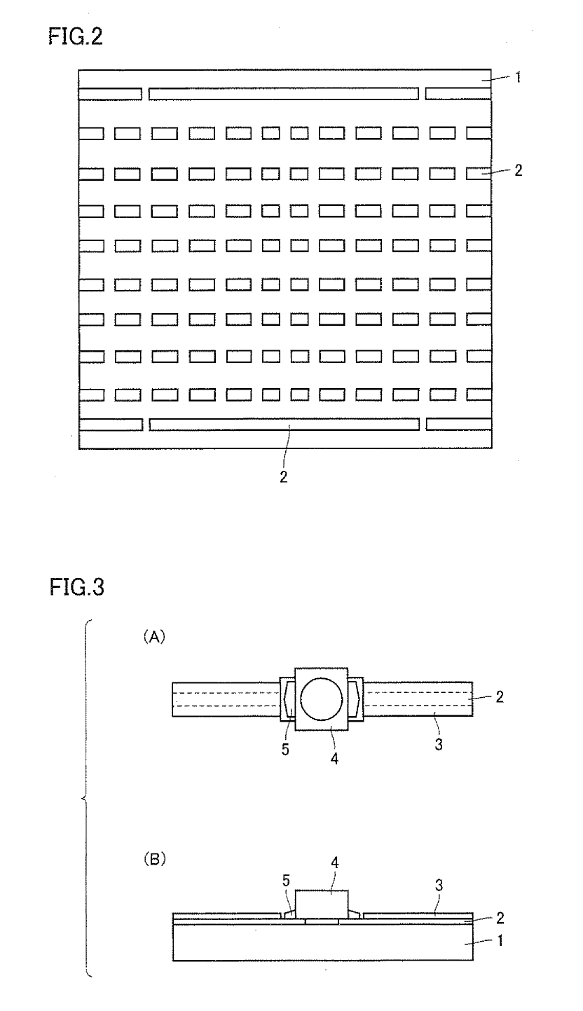

As shown in the flowchart of FIG. 1 and a schematic plan view of FIG. 2, after cleaning of a common green glass plate (transparent and colorless, 300 mm×300 mm, 1.1 mm thick) serving as a transparent glass substrate, a wiring pattern 2 is printed to be 10 μm thick through a prescribed printing mask with use of an Ag paste (containing at least Ag, Si, B, and Di components) and then baked at 500° C. for 3 hours, for example.

Next, as shown in FIGS. 1 and 3, printing and baking with use of a prescribed printing mask (not shown) is repeated twice so as to form a glass protective layer 3 on wiring pattern 2, and then checks are made on a line resistance value, an external appearance, and others. Note that FIG. 3(A) is a schematic plan view, and FIG. 3(B) shows a cross-sectional view corresponding thereto. The line resistance on the glass substrate where wiring pattern 2 is completed can be at most 0.1Ω in average, and can preferably be 0.06Ω in average. Glass protective layer 3 is transparent and includes at least two sub-layers that have a thickness of at least 10 μm in total. Preferably, glass protective layer 3 includes two sub-layers each having a thickness of 5 μm.

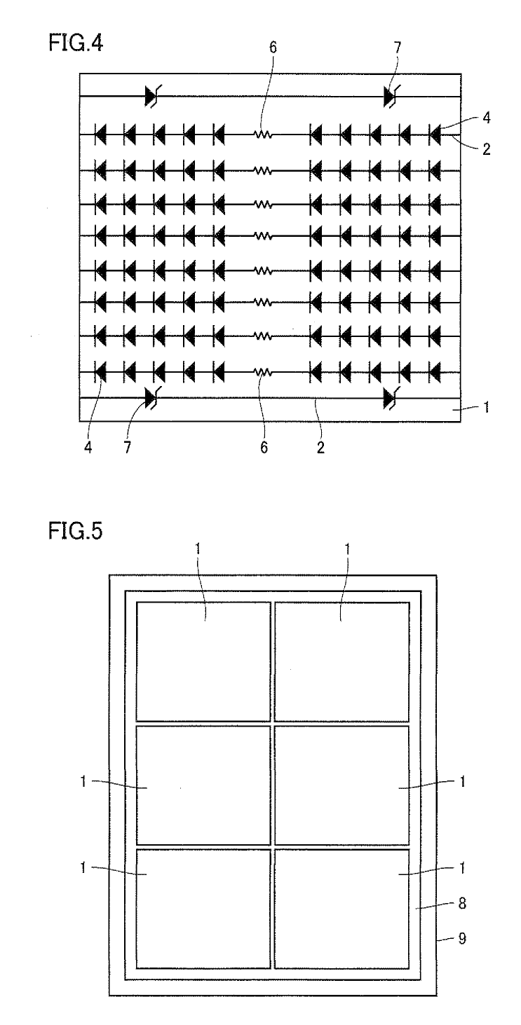

Subsequently, as shown in FIGS. 1 and 3, and a schematic plan view of FIG. 4 that includes a circuit diagram, there is performed a step of mounting LEDs 4 on wiring pattern 2. Initially, a prescribed printing mask (not shown) is used to print cream solder 5 for mounting LEDs 4. On the printed cream solder 5, eighty LEDs 4, eight limiting resistors 6, and four Zener diodes 7 are arranged by an automatic mounter, and then cream solder 5 is melted for connection in a reflow furnace.

As to cream solder 5, it is preferable to use solder having components similar to those of wiring pattern 2. For example, it is possible to utilize M705-PLG-32-11(96.5 wt % Sn, 3.0 wt % Ag, 0.5 wt % Cu) available from Senju Metal Industry Co., Ltd. As to flux for enhancing wettability between the solder and the wiring pattern, it is preferable to use flux that becomes transparent and colorless after being subjected to the reflow step.

After the LED mounting step as described above, electrical checks and optical checks are carried out for the LEDs and others mounted on the transparent glass substrate to see if no problem will occur in a lighting device to be obtained. After the electrical and optical checks are carried out, the process proceeds to a step of forming a housing.

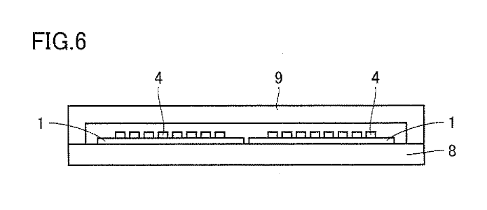

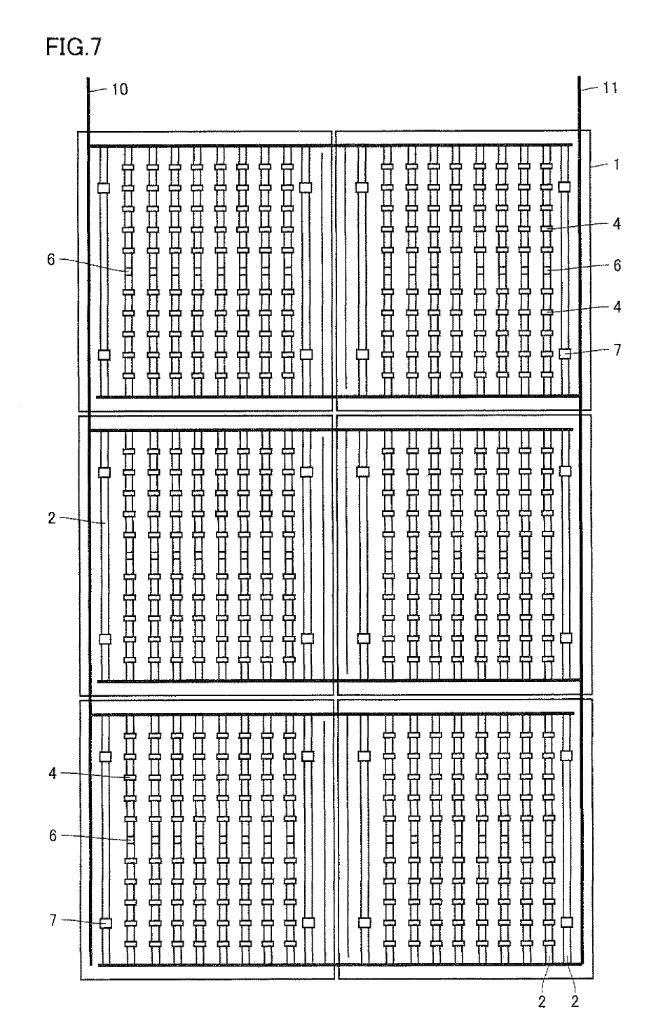

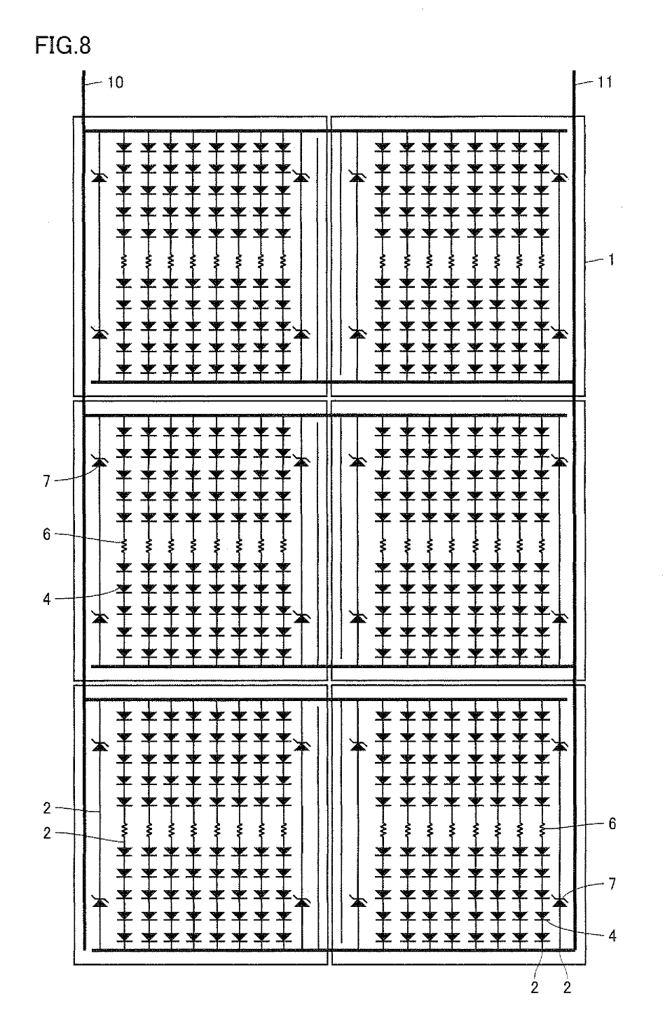

As shown in FIG. 1, a schematic plan view of FIG. 5, and a schematic cross-sectional view of FIG. 6 corresponding to FIG. 5, six transparent glass substrates 1 having LEDs 4 mounted thereon are arranged with a spacing of 2 mm on an attachment glass board (700 mm×1000 mm, 3.2 mm thick) 8 for fixing glass substrates, and bonded with EVA (ethylvinylacetate, not shown) or the like. As shown in a schematic plan view of FIG. 7 and a schematic plan view of FIG. 8 that includes a circuit diagram corresponding to FIG. 7, wirings 10 and 11 for supplying LEDs 4 with electric power are provided, and a transparent cover 9 made of flame-retardant resin (e.g., polycarbonate) and having a space therein is attached (see FIG. 6). Subsequently, checks for various electrical properties and an external appearance are carried out, and an LED lighting device is completed. The LED lighting device completed as such is attachable to a building.

In the first example described above, explanation has been given for the case of using the transparent and colorless glass substrate as transmissive glass substrate 1. Of course, however, with use of a colored transparent glass substrate or a colorless or colored ground glass substrate, having a transmittance of 70% for example, it is also possible to fabricate an LED lighting device having a daylighting property through steps similar to those in the flowchart of FIG. 1. The transmittance of glass substrate 1 is of course not limited to 70%.

In the first example described above, explanation has been given for the case of using attachment glass board 8 for fixing glass substrates. However, it is also possible to obtain similar effects with a structure that uses an attachment resin, e.g., polycarbonate board for fixing glass substrates. Furthermore, it is also of course possible to arbitrarily modify the size of transparent glass substrate 1, the numbers of the LEDs, the limiting resistors and the Zener diodes to be mounted on substrate 1, and the number of substrates 1 to be arranged on attachment board 8.

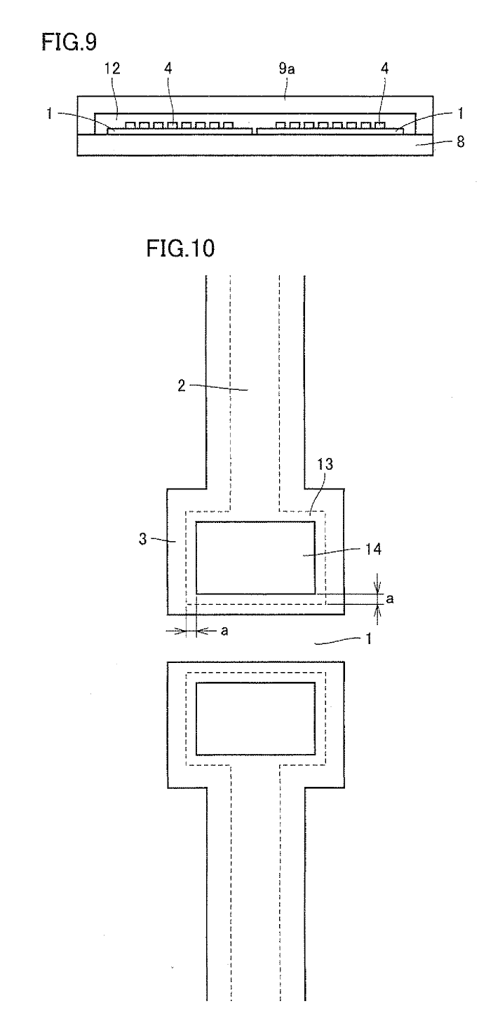

Furthermore, as shown in a schematic cross-sectional view of FIG. 9, after a plurality of transparent glass substrates 1 are joined on attachment glass board 8 for fixing glass substrates and then wirings 10 and 11 for supplying LEDs 4 with electric power are provided (see FIGS. 7 and 8), an EVA film 12, for example, may be overlaid on transparent glass substrates 1, and a transparent glass cover 9a, for example, may be arranged thereon, and subsequently EVA film 12 may be melted for bonding in a pressurized heating furnace.

### Second Example

Steps of producing a lighting device in a second example of the present invention basically follow the flowchart of FIG. 1, similarly as in the case of the first example, but include some points partially modified as compared to the first example. The modified points will hereinafter be described in further detail.

FIG. 10 shows a schematic plan view of a coating pattern of glass protective layer 3 in the step of printing the glass protective film in the second example. In this drawing, wiring pattern 2 that has been printed and baked on glass substrate 1 is coated with glass protective layer 3. Note that wiring pattern 2 includes a solder connection site (hereinafter also referred to as a “land pattern”) 13 for mounting LED 4. Glass protective layer 3 includes an opening 14 in an area located on land pattern 13. A reference character “a” in the drawing represents a distance between a peripheral edge of land pattern 13 and a peripheral edge of opening 14.

By adopting the structure as in FIG. 10, even if cream solder 5 joining LED 4 to land pattern 13 expands or shrinks owing to a drastic temperature change, it is possible to prevent occurrence of cracking in glass substrate 1. A principle of this cracking prevention can be considered as follows.

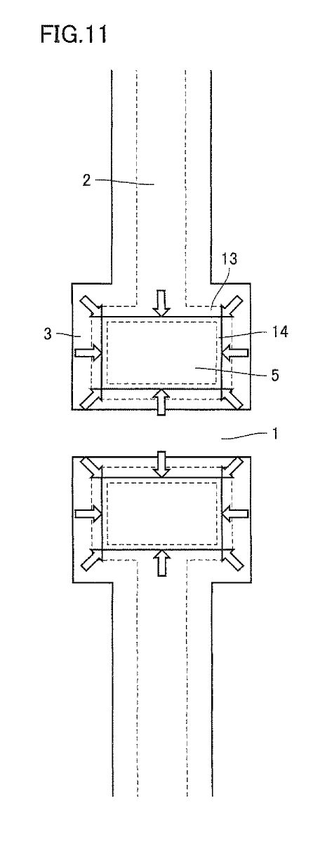

FIG. 11 is a schematic plan view that shows how cream solder 5 shrinks owing to temperature decrease. That is, arrows in FIG. 11 represent directions along which cream solder 5 shrinks. When cream solder 5 shrinks in the arrow directions, the Ag paste forming land pattern 13 and also glass protective layer 3 are given external force in the arrow directions by cream solder 5. In other words, thermal shrinkage of solder is larger than that of Ag, and thermal shrinkage of Ag is larger than that of glass, and hence cream solder 5 pulls land pattern 13 in the arrow directions, and then land pattern 13 pulls glass substrate 1 in the arrow directions.

If land pattern 13 is not at all coated with glass protective layer 3, a peripheral edge of the applied cream solder 5 coincides with or somewhat goes beyond a peripheral edge of land pattern 13. If cream solder 5 shrinks in such a state, land pattern 13 cannot favorably alleviate a stress exerted on glass substrate 1.

However, if a distance “a” (e.g., 0.2 mm) is kept between the peripheral edge of land pattern 13 and the peripheral edge of opening 14 located inside land pattern 13, the peripheral edge of cream solder 5 applied in opening 14 and the peripheral edge of land pattern 13 do not coincide with each other, so that a stress can be alleviated by land pattern 13 by distance “a”. In other words, a stress generated by shrinkage of cream solder 5 is alleviated by land pattern 13, and hence it is possible to more surely prevent occurrence of cracking in glass substrate 1.

According to the second example as described above, even in an environment where drastic temperature changes can occur, such as in a case where a lighting device is used as an external wall material, it is possible to surely prevent occurrence of cracking in glass substrate 1.

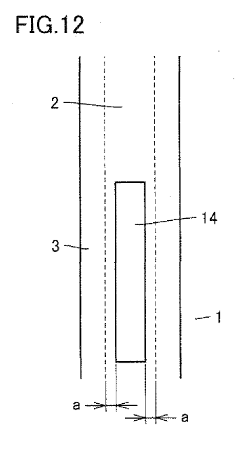

As shown in a schematic plan view of FIG. 12, by also providing opening 14 at a site on wiring pattern 2 where soldering is additionally performed, and maintaining distance “a” (e.g., 0.2 mm) between the peripheral edge of wiring pattern 2 and the peripheral edge of opening 14, it is also possible to obtain similar effects as those on land pattern 13.

Furthermore, if glass protective layer 3 is made of SiO₂, the difference between thermal shrinkage of glass protective layer 3 and thermal shrinkage of glass substrate 1 becomes small, and hence it is possible to reduce an interactive stress therebetween caused by thermal change. Furthermore, the value of distance “a” in the second example is not limited to exemplary 0.2 mm, as long as it is a value that can prevent occurrence of cracking in glass substrate 1.

In the second example, cream solder 5 is applied in openings 14 provided on land pattern 13 and on wiring pattern 2, and hence it is also possible to obtain an effect of easily applying a suitable amount of cream solder 5 in openings 14, in addition to the effect of preventing occurrence of cracking in glass substrate 1. Furthermore, in the LED mounting step in the second example, a terminal of LED 4 is arranged in opening 14 provided on land pattern 13 or on wiring pattern 2, and hence it is possible to reliably connect LED 4 to the land pattern, so that an effect of improving production yield can be expected.

According to the present invention described above, it is possible to effectively obtain daylighting from the backside of the LED-mounted substrate as well as the lighting function in the LED lighting device, and it is also possible to improve appearance and design of a building for example. Furthermore, it is also possible to obtain an effect of improving reliability of the LED lighting device and to improve easiness of maintenance that is necessary when a failure of LED occurs. With use of the resin cover, the weight and the cost of the LED lighting device are decreased, so that it becomes easy to replace the lighting device.

Furthermore, as an effect in the production process in the present invention, the glass coating is applied on the upper surface of the wiring pattern that has been formed through printing and baking of the Ag paste, except for the inner area inside the peripheral edge of the land pattern, and hence it is possible to prevent cream solder paste from spreading beyond the land pattern in the subsequent steps of printing the cream solder paste, mounting LEDs, and performing reflow soldering. Consequently, it is also possible to obtain an effect of improving the production yield of the LED lighting device, and this effect can contribute to cost reduction.

The transmissive LED lighting device itself in the present invention can of course be used so as to be attached to eaves (so-called canopy), a wall surface, a paned window portion, or the like of a building and can also be used in combination with an optically transmissive solar battery. Alternatively, it goes without saying that the LED lighting device in the present invention can be used merely as a lighting device.

### INDUSTRIAL APPLICABILITY

As described above, according to the present invention, it is possible to provide at low cost in a simple and easy manner an LED lighting device having a daylighting property and being stable even for long-term use.

1. A lighting device comprising: an optically transmissive glass substrate;
a wiring pattern formed on said glass substrate;
a plurality of light-emitting diode elements mounted to correspond to said wiring pattern;
a glass coat covering at least a part of said wiring pattern; and
an opening provided at each of appropriate sites of said glass coat;
wherein said wiring pattern is formed of a material containing silver, silicon, boron and bismuth.

2. The lighting device according to claim 1, further comprising a frame body made of resin or glass and enclosing said glass substrate.

3. The lighting device according to claim 2, wherein said glass substrate is sealed in said frame body with resin.

4. (canceled)

5. The lighting device according to claim 1, wherein said glass substrate is made of colorless or colored transparent glass, or colorless or colored ground glass.

6. The lighting device according to claim 1, wherein said wiring pattern is formed linearly along two side edges facing each other of the glass substrate and include a pattern for connection with an interconnector.

7. The lighting device according to claim 6, wherein said wiring pattern is formed to be rotationally symmetrical through 180 degrees.

8. (canceled)

9. The lighting device according to claim 1, wherein said glass coat is a two-layered glass coat.

10. The lighting device according to claim 1, wherein said glass coat is made of SiO₂.

11. (canceled)

12. The lighting device according to claim 1, wherein cream solder is applied in said opening.

13. The lighting device according to claim 1, wherein said wiring pattern includes a land pattern on which said light-emitting diode element is mounted, and in said glass coat covering the land pattern, said opening is provided with a prescribed inward distance from the peripheral edge of the land pattern.

14. The lighting device according to claim 13, wherein an electrode terminal of said light-emitting diode element is soldered in said opening on said land pattern.

15. A method of producing the lighting device of claim 1, wherein said wiring pattern is formed by baking a paste containing silver at a temperature of at least 490° C.

16. The method of producing the lighting device according to claim 15, wherein an interconnector is connected onto said wiring pattern by using reflow soldering.
